(19) United States
(12) Patent Application Publication
(10) Pub. No.: US 2003/0135985 A1
(43) Pub. Date: Jul. 24, 2003

(54) Method and apparatus for the physical and electrical coupling of a hard disk micro-actuator and magnetic head to a drive arm suspension

(76) Inventors: Ming Gao Yao, Dongguan City (CN); Masashi Shiraishi, Kowloon (HK)

Correspondence Address: KENYON & KENYON (SAN JOSE), 333 WEST SAN CARLOS ST., SUITE 600, SAN JOSE, CA, 95110, US

(21) Appl. No.: 10/103,353

(22) Filed: Mar. 20, 2002

(30) Foreign Application Priority Data
Jan. 19, 2002 (WO) PCT/CN02/00027

(51) Int. Cl. G11B 5/127; H04R 31/00; B23P 19/00

(52) U.S. Cl. 29/603.06; 29/603.03; 29/603.07; 29/729; 29/737

(57) ABSTRACT

A system and method for the physical and electrical coupling of a hard disk micro-actuator and magnetic head to a drive arm's suspension using gold ball bonding (GBB) or solder bump bonding (SBB) to prevent problems of silver paste epoxy, such as physical deformation (viscosity) due to humidity/temperature alteration.

### BACKGROUND INFORMATION

The present invention relates to magnetic hard disk drives. More specifically, the present invention relates to a system for the physical and electrical coupling of a hard disk micro-actuator and magnetic head to a drive arm's suspension.

In the art today, different methods are utilized to improve recording density of hard disk drives. FIG. 1 provides an illustration of a typical drive arm configured to read from and write to a magnetic hard disk. Typically, voice-coil motors (VCM) 102 are used for controlling a hard drive's arm 104 motion across a magnetic hard disk 106. Because of the inherent tolerance (dynamic play) that exists in the placement of a recording head 108 by a VCM 102 alone, micro-actuators 110 are now being utilized to ‘fine-tune’ head 108 placement, as is described in U.S. Pat. No. 6,198,606. A VCM 102 is utilized for course adjustment and the micro-actuator then corrects the placement on a much smaller scale to compensate for the VCM's 102 (with the arm 104) tolerance. This enables a smaller recordable track width, increasing the ‘tracks per inch’ (TPI) value of the hard drive (increased drive density).

FIG. 2 provides an illustration of a micro-actuator as used in the art. Typically, a slider 202 (containing a read/write magnetic head; not shown) is utilized for maintaining a prescribed flying height above the disk surface 106 (See FIG. 1). Micro-actuators may have flexible beams 204 connecting a support device 206 to a slider containment unit 208 enabling slider 202 motion independent of the drive arm 104 (See FIG. 1). An electromagnetic assembly or an electromagnetic/ferromagnetic assembly (not shown) may be utilized to provide minute adjustments in orientation/location of the slider/head 202 with respect to the arm 104 (See FIG. 1).

Physical and electrical coupling of a hard disk micro-actuator and magnetic head to a drive arm's suspension can be difficult due to the environment within which it must operate. Using silver paste (high Mercury-content epoxy) for physical/electrical attachment has drawbacks due to the viscous nature of epoxy under changing temperature and humidity.

It is therefore desirable to have a system for physical and electrical coupling of a hard disk micro-actuator and magnetic head to a drive arm's suspension that avoids the above-mentioned problems as well as having additional benefits.

### BRIEF DESCRIPTION OF THE DRAWINGS

FIG. 1 provides an illustration of a drive arm configured to read from and write to a magnetic hard disk as used in the art.

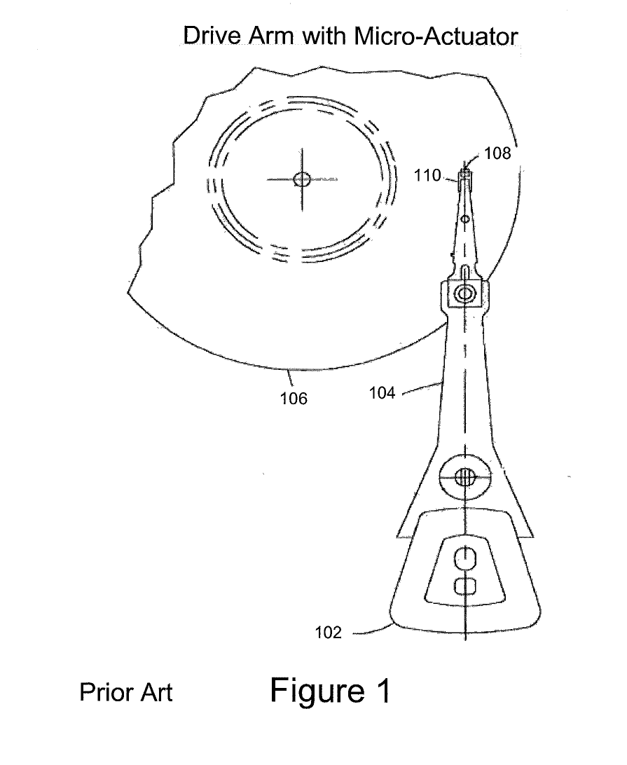

FIG. 2 provides an illustration of a micro-actuator as used in the art.

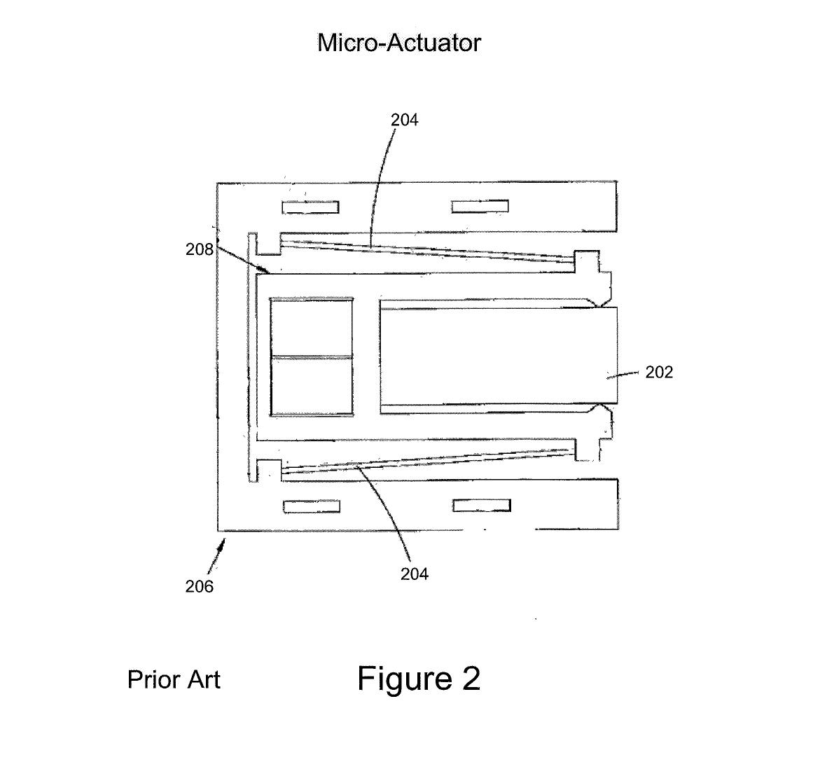

FIG. 3 provides an illustration of a hard disk drive head gimbal assembly (HGA) with a ‘U’-shaped micro-actuator under principles of the present invention.

FIG. 4 provides a detailed illustration of a magnetic head (and slider) with a ‘U’-shaped micro-actuator under principles of the present invention.

FIG. 5 provides an illustration of a ‘U’-shaped micro-actuator for further explanation under principles of the present invention.

FIG. 6 provides another illustration of a micro-actuator and head coupled to a suspension by gold ball bonding (GBB) under principles of the present invention.

FIGS. 7a-d illustrate the deformation problem with using silver paste (epoxy) for attachment under situations of changing humidity and/or temperature.

FIGS. 8a-d illustrate the correction of the deformation problem with gold ball bonding (GBB) under principles of the present invention.

### DETAILED DESCRIPTION

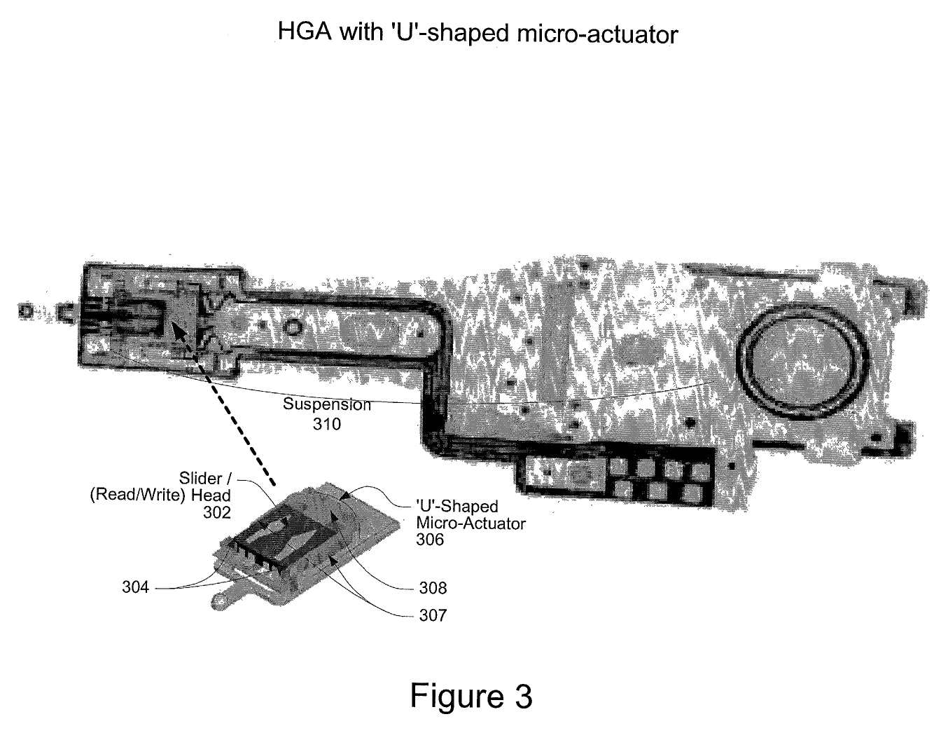

FIG. 3 provides an illustration of a hard disk drive head gimbal assembly (HGA) with a ‘U’-shaped micro-actuator under principles of the present invention. In one embodiment, a slider (with read/write head) 302 is bonded at two points 304 to a ‘U’-shaped micro-actuator 306. Further, in an embodiment, the ‘U’-shaped micro-actuator has a piezoelectric PZT (Piezoelectric Transducer) beam (arm) 307 on each side of a Zirconia support frame (actuator base/bottom arm) 308. As explained below, the micro-actuator is coupled to and supported by an arm suspension 310.

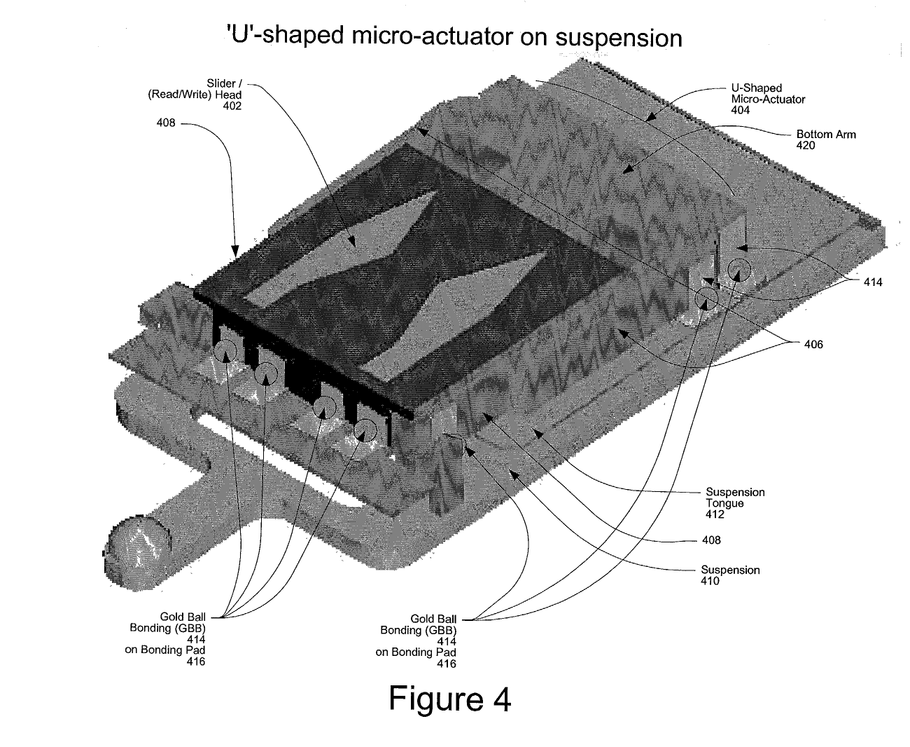

FIG. 4 provides a detailed illustration of a magnetic head (and slider) 402 with a ‘U’-shaped micro-actuator 404 under principles of the present invention. PZT material has an anisotropic structure whereby the charge separation between the positive and negative ions provides for electric dipole behavior. When a potential is applied across a poled piezoelectric material, Weiss domains increase their alignment proportional to the voltage, resulting in structural deformation (i.e. regional expansion/contraction) of the PZT material. The PZT structures 406 bend (in unison), the Zirconia arms 408, which are bonded to the PZT structures 406 bend also, causing the head/slider 402 to adjust its position in relation to the micro-actuator 404 (for magnetic head fine adjustments). As explained below, the bottom arm 420 is secured to the suspension tongue 412, maintaining the orientation of the suspension 410.

As stated, physical and electrical coupling of a hard disk micro-actuator 404 and magnetic head 402 to a drive arm's suspension 410 can be difficult due to the environment within which it must operate. Using silver paste (high Mercury-content epoxy) for physical/electrical attachment has drawbacks due to the viscous nature of epoxy under changing temperature and humidity, as explained below.

Further, problems associated to silver migration exist with the usage of silver paste. Migration is a phenomenon of silver (atom or ion) transports, which occurs by an electro-chemical process. It occurs predominantly in high-humidity environments having an applied electric field. One problem associated to silver migration involves metal deposits traveling from cathode to anode. This type of migration causes unwanted contamination between layers (which are dendritic structures) of the multi-layered PZT. Another problem with this kind of silver migration is the potential for an electrical short. The migration can cause a short between layers of the PZT or between an anode or cathode pad to ground. Another type of silver migration involves metal spreading inside the resin of the silver paste, forming a metallic cloud. It may penetrate the insulation film and reach a surface, damaging electrical connections between the PZT 406 and suspension 410.

To physically mount and electrically couple the micro-actuator 404 to the suspension 410, silver paste may be used, but as stated above and further explained below, drawbacks due to physical deformity are possible with epoxy under changing temperature and/or humidity. In an embodiment of the present invention, a ball bonding operation is performed such as gold ball bonding (GBB) 414 or solder bump bonding (SBB) to physically/electrically couple the micro-actuator 404 to the suspension 410. GBB may involve arc-welding with a wire material that is approximately 95%-99% gold. In an embodiment, the melted gold wire mixes with the gold material of the suspension and micro-actuator bonding pads 416 under applied pressure. As stated, solder bump bonding (SBB) is an alternative embodiment for the present invention. Other suitable ball bonding materials may be used to physically/electrically couple the micro-actuator 404 to the suspension 410. Also, to electrically couple the magnetic head 402 to the suspension 410 (performed prior to micro-actuator/suspension attachment), GBB 414 may be utilized. As above, solder bump bonding (SBB) is an alternative embodiment.

As explained below, in one embodiment the bottom arm 420 is attached to the suspension tongue 412 by epoxy, and in an alternative embodiment, the adhesive is resin. This secures the micro-actuator 404 to the arm suspension 410.

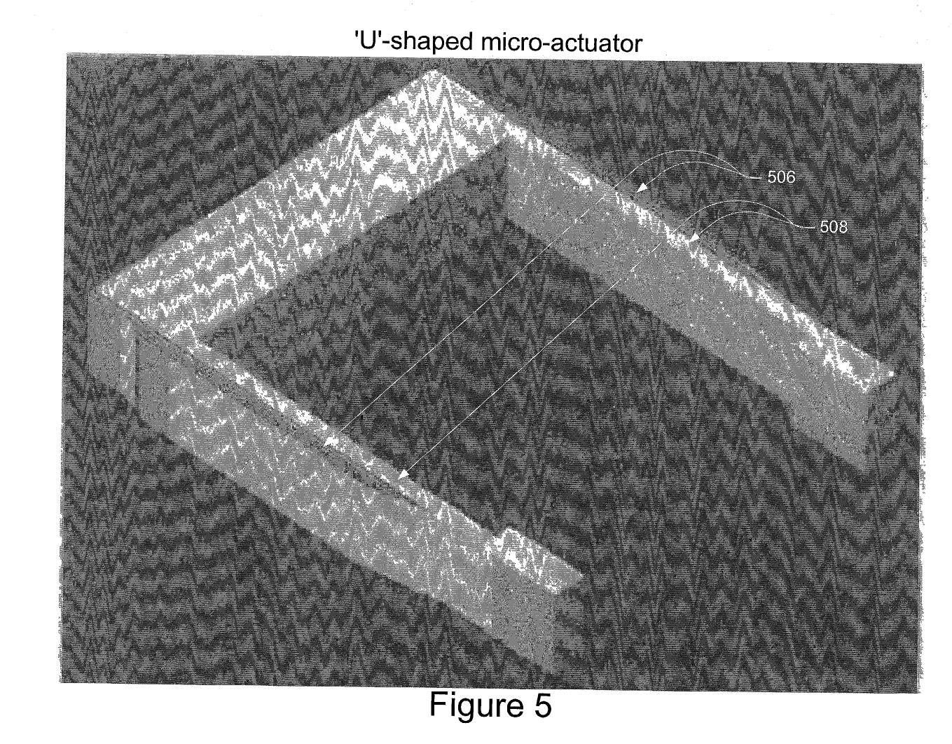

FIG. 5 provides an illustration of a ‘U’-shaped micro-actuator for further explanation under principles of the present invention. As stated above, when a potential is applied across a poled piezoelectric material, structural deformation (i.e. regional expansion/contraction) of the to PZT material results. As the PZT structures 506 bend (in unison), the Zirconia arms 508, which are bonded to the PZT structures 506 bend also, causing the head/slider (not shown) to adjust its position in relation to the micro-actuator (for magnetic head fine adjustments).

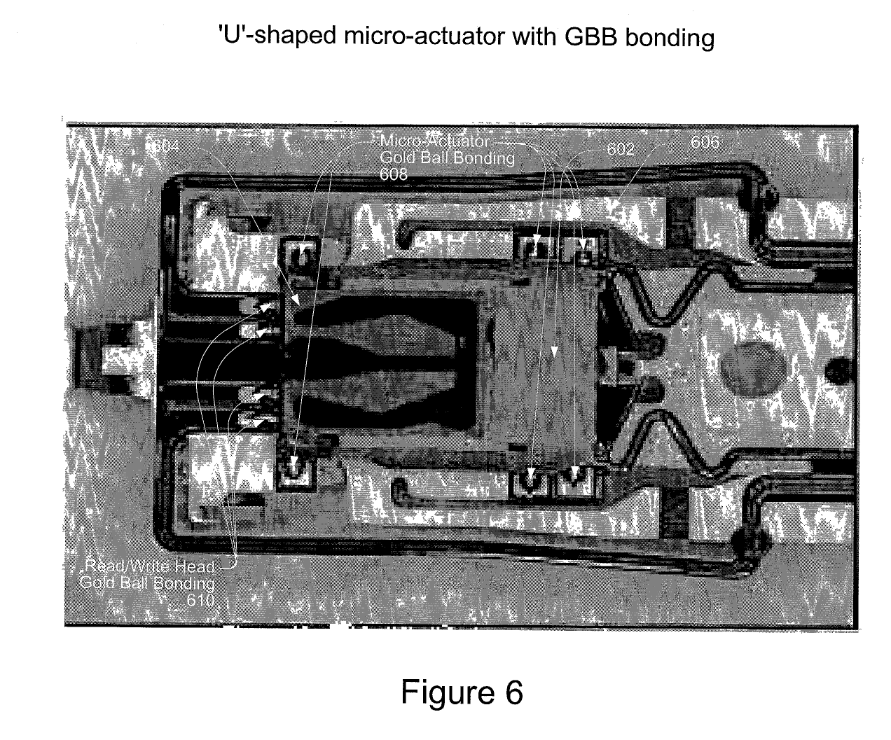

FIG. 6 provides another illustration of a micro-actuator 602 and head 604 coupled to a suspension 606 by gold ball bonding (GBB) under principles of the present invention. In one embodiment of the present invention, six micro-actuator GBB application sites (three on each side) 608 are used to physically/electrically couple the micro-actuator 602 to the suspension 606. Four head GBB application sites (upon bond pads) 610 are used to secure the head 604 to the suspension 606 for the physical/electrical connection.

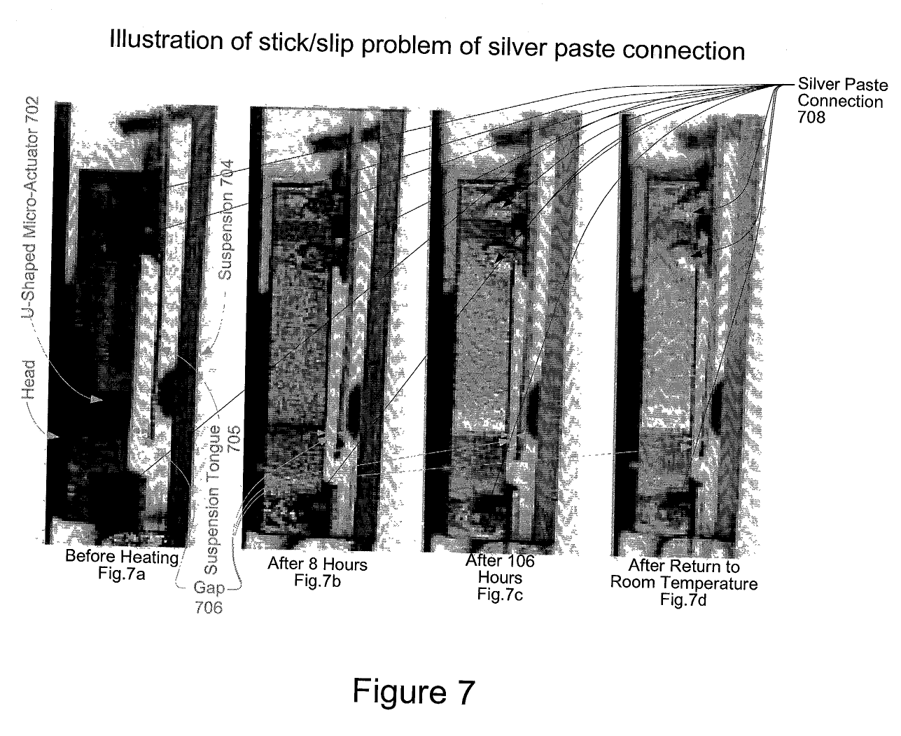

FIGS. 7a-d illustrate the deformation problem with using silver paste (epoxy) for physical/electrical coupling under situations of changing humidity and/or temperature. As shown in FIG. 7a, a specific gap 706 exists between the micro-actuator 702 and the suspension tongue 705. This gap 706 should be consistent along the length of the micro-actuator 702 (micro-actuator should be parallel to suspension tongue). FIG. 7b illustrates that after eight hours of heating, the silver paste (high-Mercury epoxy) 708 and micro-actuator mounting epoxy, which soften with changes in temperature or humidity, have allowed the micro-actuator 702 to physically shift with respect to the suspension 704, causing the micro-actuator 702 to no longer be parallel to the suspension tongue 705 (and reducing the gap 706 between the micro-actuator and the suspension tongue). As shown in FIG. 7c, over prolonged heating, the gap 706 continually decreases. FIG. 7d illustrates that even after the structure is returned to room temperature, the gap remains smaller than it was before heated.

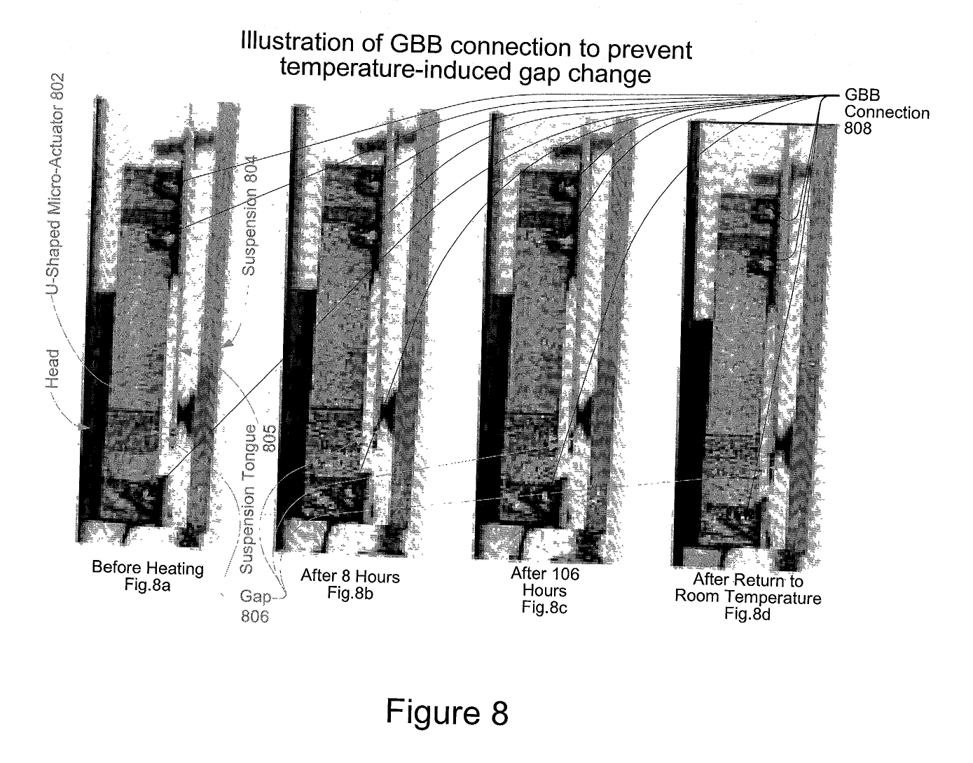

FIGS. 8a-d illustrate the correction of the deformation problem with gold ball bonding (GBB) under principles of the present invention. Through heating the structure for the same periods of time (and returning to room temperature) in an embodiment, the gap 806 between the micro-actuator 802 and the suspension tongue 805 remains constant (holding the micro-actuator parallel to the suspension).

Further, because gold has very low viscosity when melted (as compare with silver, lead, copper, tin, etc.), the GBB bonds will not have the migration (contamination/short) problems described above.

Although several embodiments are specifically illustrated and described herein, it will be appreciated that modifications and variations of the present invention are covered by the above teachings and within the purview of the appended claims without departing from the spirit and intended scope of the invention.

1. A system to couple an actuator element to a suspension element comprising:
an actuator element adapted to be physically supported by and coupled to a suspension element by at least one application site of a bonding agent, wherein said bonding agent is a conductor ball bonding material.

2. The system of claim 1, wherein the actuator element is further adapted to be electrically coupled to said suspension element by said at least one application site of said bonding agent.

3. The system of claim 2, wherein the actuator element is coupled to said suspension element by gold ball bonding (GBB).

4. The system of claim 2, wherein the actuator element is coupled to said suspension element by solder bump bonding (SBB).

5. The system of claim 3, wherein the actuator element is a micro-actuator.

6. The system of claim 5, wherein the micro-actuator is a piezoelectric, U-shaped micro-actuator.

7. The system of claim 6, wherein the actuator element is adapted to be coupled to said suspension element by s aid at least one application site of said bonding agent upon at least one respective electric bond pad.

8. The system of claim 7, wherein the suspension element is a suspension tongue.

9. A system to couple an actuator element to a suspension element comprising:
a suspension element adapted to physically support and to be physically coupled to an actuator element by at least one application site of a bonding agent, wherein said bonding agent is a conductor ball bonding material.

10. The system of claim 9, wherein the suspension element is further adapted to be electrically coupled to said actuator element by said at least one application site of said bonding agent.

11. The system of claim 10, wherein the actuator element is coupled to said suspension element by gold ball bonding (GBB).

12. The system of claim 10, wherein the actuator element is coupled to said suspension element by solder bump bonding (SBB).

13. The system of claim 10, wherein the actuator element is a micro-actuator.

14. The system of claim 13, wherein the micro-actuator is a piezoelectric, U-shaped micro-actuator.

15. The system of claim 14, wherein the suspension element is adapted to be coupled to said actuator element by said at least one application site of said bonding agent upon at least one respective electric bond pad.

16. The system of claim 15, wherein the suspension element is a suspension tongue.

17. A system to couple a magnetic head to a suspension element comprising:
a magnetic head adapted to be electrically coupled to a suspension element by at least one application site of a bonding agent, wherein said bonding agent is a conductor ball bonding material.

18. The system of claim 17, wherein the magnetic head is coupled to said suspension element by gold ball bonding (GBB).

19. The system of claim 17, wherein the actuator element is coupled to said suspension element by solder bump bonding (SBB).

20. The system of claim 17, wherein the magnetic head is a hard drive magnetic head.

21. The system of claim 20, wherein the magnetic head is adapted to be coupled to said suspension element by said at least one application site of said bonding agent upon at least one respective electric bond pad.

22. A method to couple an actuator element to a suspension element comprising:
adapting an actuator element to be physically supported by and coupled to a suspension element by at least one application site of a bonding agent, wherein said bonding agent is a conductor ball bonding material.

23. The method of claim 22, wherein the actuator element is further adapted to be electrically coupled to said suspension element by said at least one application site of said bonding agent.

24. The method of claim 23, wherein the actuator element is coupled to said suspension element by gold ball bonding (GBB).

25. The method of claim 23, wherein the actuator element is coupled to said suspension element by solder bump bonding (SBB).

26. The method of claim 23, wherein the actuator element is a micro-actuator.

27. The method of claim 26, wherein the micro-actuator is a piezoelectric, U-shaped micro-actuator.

28. The method of claim 27, wherein the actuator element is adapted to b e coupled to said suspension element by s aid at least one application site of said bonding agent upon at least one respective electric bond pad.

29. The method of claim 28, wherein the suspension element is a suspension tongue.

30. A method to couple a magnetic head to a suspension element comprising:
a magnetic head adapted to be electrically coupled to a suspension element by at least one application site of a bonding agent, wherein said bonding agent is a conductor ball bonding material.

31. The method of claim 30, wherein the magnetic head is coupled to said suspension element by gold ball bonding (GBB).

32. The method of claim 30, wherein the actuator element is coupled to said suspension element by solder bump bonding (SBB).

33. The method of claim 30, wherein the magnetic head is a hard drive magnetic head.

34. The method of claim 33, wherein the magnetic head is adapted to be coupled to said suspension element by said at least one application site of said bonding agent upon at least one respective electric bond pad.
